(19) United States
(12) Patent Application Publication
(10) Pub. No.: US 2010/0267562 A1
(43) Pub. Date: Oct. 21, 2010

(54) ACTIVATION OF HIGH PROTEIN CORN GLUTEN BY PH MODIFICATION

(75) Inventor: Nick E. Christians, Nevada, IA (US)

Correspondence Address: SCHWEGMAN, LUNDBERG & WOESSNER, P.A., P.O. BOX 2938, MINNEAPOLIS, MN, 55402, US

(73) Assignee: Iowa State University research Foundation, Inc., Ames, IA (US)

(21) Appl. No.: 12/762,863

(22) Filed: Apr. 19, 2010

Related U.S. Application Data
(60) Provisional application No. 61/170,269, filed on Apr. 17, 2009.

(51) Int. Cl. A01N 65/44

(52) U.S. Cl. 504/189

(57) ABSTRACT

Compositions and methods for inhibiting undesirable plants.

### REFERENCE TO RELATED APPLICATIONS

This application claims priority under 35 U.S.C. 119(e) from U.S. Provisional Application Ser. No. 61/170,269 filed Apr. 17, 2009, which is incorporated herein by reference.

### BACKGROUND ON THE INVENTION

Corn gluten meal (CGM) is a natural preemergence weed control that has long been known for its broad spectrum control of weeds in turfgrass and other crops (Bingaman and Christians, 1995; Christians, 1991; Christians, 1993; Normecke and Christians, 1993). As a by-product of the corn wet-milling process, CGM is often used as feed additives for many animals. Also, as a primarily protein fraction, CGM is 10% by weight nitrogen, making it a natural fertilizer as well as a natural herbicide. Its nontoxic nature also led the Environmental Protection Agency (EPA) to declare CGM exempt from the regulations that synthetic pesticides must adhere to (EPA, 1997).

Growing concern for the environment and the rising popularity of naturally grown crops has led to an increased need for natural weed controls. In many farming operations, weeds are a serious problem. A growing demand for natural weed controls calls for more effective natural alternatives.

### SUMMARY OF THE INVENTION

Given the increased demand for natural herbicides, increasing the efficacy of existing natural products such as CGM is of great interest and importance. During studies designed to determine the effect of pH on the herbicidal activity of corn gluten meal (CGM), it was unexpectedly found that decreasing the pH of CGM increased its herbicidal efficacy.

One embodiment of the invention provides isolated corn gluten meal (CGM) with a pH lower than about 4.0, such as about 2.0 to about 3.5 or about 3.0.

Another embodiment provides isolated acidified corn gluten meal (CGM) prepared by the steps of: a) adjusting pH of a gluten stream (e.g., 70% or 68% or 60% protein) with an acid to a pH of lower than about 4.0; and b) drying said pH adjusted gluten stream to yield said isolated acidified CGM, wherein the gluten stream is separated from corn during corn wet milling processing.

Another embodiment provides isolated acidified corn gluten meal (CGM) prepared by the steps of: a) suspending CGM in water (or other appropriate solvent or salt solution); b) adjusting pH of said suspended CGM with an acid to a pH of lower than about 4.0; and c) drying said pH adjusted suspended CGM to yield said isolated acidified CGM.

In one embodiment, the adjusted pH is about 2.0 to about 3.5. In another embodiment, the adjusted pH is about 2.0 or about 3.0. In one embodiment, the acid is hydrochloric acid, lactic acid, acetic acid or a combination thereof.

One embodiment provides a method to prepare an acidified CGM comprising a) adjusting pH of a gluten stream with an acid to a pH of lower than about 4.0; and b) drying said pH adjusted gluten stream to yield said isolated acidified CGM, wherein the gluten stream is separated from corn during corn wet milling processing.

Another embodiment provides a method to prepare an acidified CGM comprising a) suspending CGM in water; b) adjusting pH of said suspended CGM with an acid to a pH of lower than about 4.0; and c) drying said pH adjusted suspended CGM to yield said isolated acidified CGM.

In one embodiment, the adjusted pH is about 2.0 to about 3.5. In another embodiment, the adjusted pH is about 2.0 or about 3.0. In one embodiment, the acid is hydrochloric acid, lactic acid, acetic acid or a combination thereof.

Another embodiment provides a method for selectively inhibiting the growth of undesirable plants in a plot of soil comprising applying acidified CGM prior to the emergence of the undesirable plants in an amount effective to inhibit the growth of the undesirable plants. In one embodiment, the acidified CGM is applied in an amount effective to inhibit the root development of the undesirable plants. In another embodiment, the plot of soil comprises desirable plants. In one embodiment, the acidified CGM is applied after emergence of the desirable plants. One embodiment further comprises transplanting desirable plants into the plot of soil.

In one embodiment, the CGM is acidified to a pH of lower than about 4.0, such about 2.0 to about 3.5, including 2.0 and 3.0.

In one embodiment, the undesirable plants are grassy weeds or broadleaf weeds. In another embodiment, the desirable plants are monocotyledonous plants. In one embodiment, the desirable plants are turfgrasses, while in another embodiment, the desirable plants are dicotyledonous plants. In one embodiment, the desirable plants are berry plants, such as strawberries, or ornamental flowers.

In one embodiment, the amount of acidified CGM applied to the plot is from about 5 to about 40 lbs. per 1000 square feet.

### BRIEF DESCRIPTION OF THE DRAWINGS

FIG. 1 depicts perennial ryegrass seedling counts after germination while exposed to 97.7 g·m⁻² 70% protein CGM at pH 4, 5, 6, 7, or 8. Pots were hand irrigated until germination was observed. A drying period was then imposed on pots after which hand irrigation continued for one week. Points are the mean of three replicates, and error bars represent the standard error of the means.

FIG. 2 depicts perennial ryegrass seedling counts after germination while exposed to 97.7 g·m⁻² 70% protein CGM at pH 2, 3, 4, or 5. Pots were hand irrigated until germination was observed. A drying period was then applied to pots after which hand irrigation was resumed for one week and seedling counts were taken. Points are the mean of four replicates, and error bars represent the standard error of the means.

FIG. 3 depicts pH data analyzed using regression analysis. All treatments reduced perennial ryegrass establishment as compared to the untreated control. Raising the pH of the 70% cgm material to pH 5 reduced its activity and acidifying it with acetic, lactic, or HCl increased its activity. Green dye alone did not improve the activity of CGM.

### DETAILED DESCRIPTION OF THE INVENTION

The invention provides an acidified corn gluten meal (CGM) that contains about 60 to about 70% protein (dry basis), including about 60%, about 68% and about 70% protein (dry basis; however, can include higher and lower (e.g., about 45%, about 50%, about 55%, about 65%) protein concentrations), which is dried and applied to or mixed in the soil in order to keep weeds from emerging. It was determined that making the material more acidic (below a pH of about 4) increased herbicidal effect. Thus, the invention further provides the use of acidified CGM for weed control. Additionally, the CGM with higher protein percentages (e.g., above 60%) not only provides higher protein content, but also higher nitrogen content to provide enhanced activity of the CGM (e.g., fertilizer (source of slow-release nitrogen (N)).

Corn gluten meal is commercially available as a by-product of corn milling (for example, it is commercially available from many sources including Grain Processing Corporation of Muscatine, Iowa). It is made by drying the liquid gluten stream separated from corn during corn wet milling processing. In the wet milling process of corn, the following fractions are obtained: corn starch, corn oil, defatted corn germ, corn hulls, corn steep liquor, and corn gluten (the protein fraction). Corn gluten is typically separated from the starch stream by centrifugation to yield a thick, yellow slurry of corn gluten containing 15 to 20% solids. Conventionally, corn gluten is filtered and dried to produce solid corn gluten meal (about 68-70% protein), which is diluted to 60% protein and sold as an animal feed product. Corn gluten meal is quite insoluble in water and is typically composed of protein (60-70%, dry basis) carbohydrate (20-25%, dry basis), fat (3-5%, dry basis) and ash (3-5%, dry basis).

The present acidified corn gluten meal is prepared by a process comprising treating an aqueous suspension of corn protein with an acid. Alternatively, the corn protein can be dried, reconstituted with water (suspension), acidified with an appropriate acid and dried. The acid can include any acid capable of reducing the pH of the CGM, such as any strong organic (e.g., those acids having a pKₐ<−1.74) or inorganic acid, including hydrochloric acid, acetic acid, citric acid, boric acid, formic acid, carbonic acid, lactic acid, perchloric acid, malic acid, hydroiodic acid, hydrobromic acid, orthophosphoric acid, sulfuric acid, nitric acid, tartaric acid, bromic acid, perbromic acid, iodic acid, periodic acid, chloric acid, oxalic acid, ascorbic, H₂SO₄ or a combination thereof. Additionally, a colorant can be added to the CGM (e.g., a dye to color the CGM, for example, green, yellow, purple, orange—any desired color). Also, the CGM described herein may be diluted (at a wet or dry stage) to reduce the amount of protein (reduction in protein concentration) in the final product.

The dry product can be applied by the use of conventional spreaders or dusters used for solid fertilizers or herbicides and can be applied as a dust, pellets, granules and the like. The amount of corn gluten meal which can be applied can vary over a wide range. For example, corn gluten meal can be applied at a level of 0.003-10 g/dm² of soil area, such as at a level of about 0.25-4 g/dm² of soil area. Also, CGM can be applied within the range of a concentration from about 5 lbs./1000 sq. ft. to about 40 lbs./1000 sq. ft., including from about 10 lbs./1000 sq. ft. to about 30 lbs./1000 sq. ft., such as about 20 lbs./1000 sq. ft. The composition can be simply surface-applied, or it can be mixed into the upper layer of the soil following application. As used herein “soil” or “plot of soil” is intended broadly cover volumes of solid plant support material such as the mixture of organic and inorganic materials conventionally referred to as “soil,” as well as synthetic soils (or “soilless soils”) and other solid supports such as beds of pebbles, sand, moss and the like. The solid plant support material may be potted, or otherwise contained, or may be a preselected portion of the ground.

The corn gluten meal is effective to prevent the emergence of a wide variety of undesirable plants, including broadleaf weeds, such as smartweed, velvetleaf, redroot, pigweed, lambsquarters, latchweed, bedstraw, black medic, buckhorn plantain, annual purslane, black and nightshade; and grassy weeds such as crabgrass, annual bluegrass, creeping bentgrass, barnyard grass, orchard grass, woolly cupgrass, foxtails, shattercane, Kentucky bluegrass, Bermudagrass, perennial ryegrass and tall fescue. Thus, corn gluten meal can be used as a preemergence herbicide for application to established plots desirable plants, including both monocotyledonous plants and dicotyledonous plants. Monocotyledonous crops include the grains; corn, sorghum, rice, oats, wheat, rye, millet, turfgrasses and the like. Dicotyledonous crops include fruits, fibers, herbs, vegetables, ornamental flowers and foliage, and legumes, including berry plants such as strawberries, blueberries and raspberries, soybeans, potatoes, spinach, cauliflower, tomatoes, tobacco, beans, beets, cotton, peas, squash, melons, canola and the like.

While applicant does not wish to be bound by any theory it is believed that the corn gluten meal, when applied to a soil plot, inhibits root development of undesirable plants or “weeds” around the time of germination. As a result, as soon as the plant begins to grow, it will undergo root stress and die. Thus, while the corn gluten meal does not prohibit germination, it nevertheless does not allow the root structure to develop sufficient that the weed can grow to a healthy plant. As a result, it dies from the lack of root growth.

As recognized by those skilled in the art, preemergence herbicides are generally applied after the emergence or rooting of the desirable plants, but prior to weed emergence. The timing of application will vary, depending upon the specific crop production system, the area of the country in which the CGM is applied and the weed species involved. For example, in general, for areas of the upper Midwest, application is desirable prior to May 1st of any growing season, for control of crabgrass.

Following application of the acidified CGM to the soil and planting or establishing of desirable plants in the plot, additional amounts of CGM can be applied as needed, to prevent the growth of undesirable plants while not inhibiting the growth of the desirable plants, or otherwise harming them.

### EXAMPLES

The following examples are provided in order to demonstrate and further illustrate certain embodiments and aspects of the present invention and are not to be construed as limiting the scope thereof.

### Materials and Methods

### pH Adjustment I

The 70% protein CGM (pH 4) was adjusted to pH 5, 6, 7 and 8 by the addition of concentrated potassium hydroxide to an aqueous slurry of CGM. Water was evaporated from CGM slurry by placing in a drying oven at 67° C. Mixtures were left in the drying oven until CGM was only slightly moist. The CGM was then removed from the drying oven and powdered with a mortar and pestle after which it was allowed to completely dry at room temperature for 24 hours.

Each CGM pH level, including an unadjusted control, was added to pots at a rate of 97.7 g·m⁻². Each pH level was replicated 3 times. Perennial ryegrass seeds were added to all pots at a rate of 9.8 g·m⁻². The CGM and seeds were then incorporated into the upper 6 mm of soil.

### pH Adjustment II

The 70% protein CGM (pH 4) was adjusted to pH 2, 3 and 5. Adjustment to pH 2 and 3 was done by adding concentrated hydrochloric acid into an aqueous CGM slurry until the desired pH was achieved. Adjustment to pH 5 was done by adding concentrated potassium hydroxide.

Water was then evaporated from the mixture using a drying oven at 67° C. Beakers remained in the oven until CGM was only slightly moist. Beakers were then removed from the drying oven and the CGM was powdered using a mortar and pestle. Powdered CGM was then allowed to dry at room temperature for 24 hours.

Each CGM pH level, including the unadjusted control (pH 4), was applied to the soil at 97.7 g·m⁻². Each pH level was replicated four times. Perennial ryegrass seeds were then added uniformly to pots at a rate of 9.8 g·m⁻². The CGM and seeds were then incorporated into the upper 6 mm of soil.

### pH Adjustment III

The dried 70% protein corn gluten meal material described earlier was suspended in water for pH modification. Suspension was achieve by placing 5 grams of dried material in 20 ml of deionized, distilled water. The pH of the suspended material was determined to be pH 4. Several acids were used to acidify the suspension to pH 3.3, 3, or 2 (Table 1). The pH of an addition sample was increased to pH 5 with potassium hydroxide (KOH). The green dye material is a green dye (e.g., COLORFAST GREEN 2 (Becker Underwood, Inc., Ames Iowa)) with a pH of 3.3. The acidified suspensions were then air dried. Subsamples were suspended in deionized, distilled water and the pH was rechecked to determine that the pH of the material had been appropriately modified. The air dried samples were ground with a mortar and pestle into a powder.

TABLE 1
Treatments included in the pH modification study.

| Treatment | |
|---|---|
| number | Treatment |
| 1 | Control |
| 2 | 70% at pH 4 |
| 3 | Green Dye pH 3.3 |
| 4 | Green Dye pH 2 (Phosphoric) |
| 5 | Green Dye pH 2 (H₂SO₄) |
| 6 | HCl pH 3 |
| 7 | HCl pH 2 |
| 8 | Lactic pH 3 |
| 9 | Acetic pH 3 |
| 10 | H₂SO₄ pH 3 |
| 11 | H₂SO₄ pH 2 |
| 12 | Phosphoric pH 3 |
| 13 | Phosphoric pH 2 |
| 14 | KOH pH 5 |

A Nicollet (fine-loamy, mixed, mesic-Aquic Hapludolls) soil with 14 g·kg⁻¹ phosphorus, 95 g·kg⁻¹ potassium, 3.3% organic matter, and a pH of 7.4, collected from the turfgrass study area at the Iowa State University Horticulture research station, was used for the bioassay. The soil, taken from 10 different locations at a depth of 1.5 cm, was homogenized before use.

The pots used had a surface area of 100 cm² and were filled uniformly with the soil. Perennial ryegrass was seeded at an equivalent of 4 lb seed/1000 ft². The treatments listed in Table 1 were applied at the equivalent of 20 lb product/1000 ft² to the soil surface. The study was conducted as a completely randomized design with 5 replications. Pots were placed on a greenhouse bench and received only natural sunlight. Temperatures ranged from 20 to 27° C.

Pots were watered as needed to maintain moisture levels conducive to germination. Pots were watered until shoot emergence was observed, at which time watering was suspended until wilting was observed. Watering was then resumed for a period of 5 days. The surviving seedlings were counted and data were reported as the number of live perennial ryegrass seedlings.

### Results

### pH Adjustment I

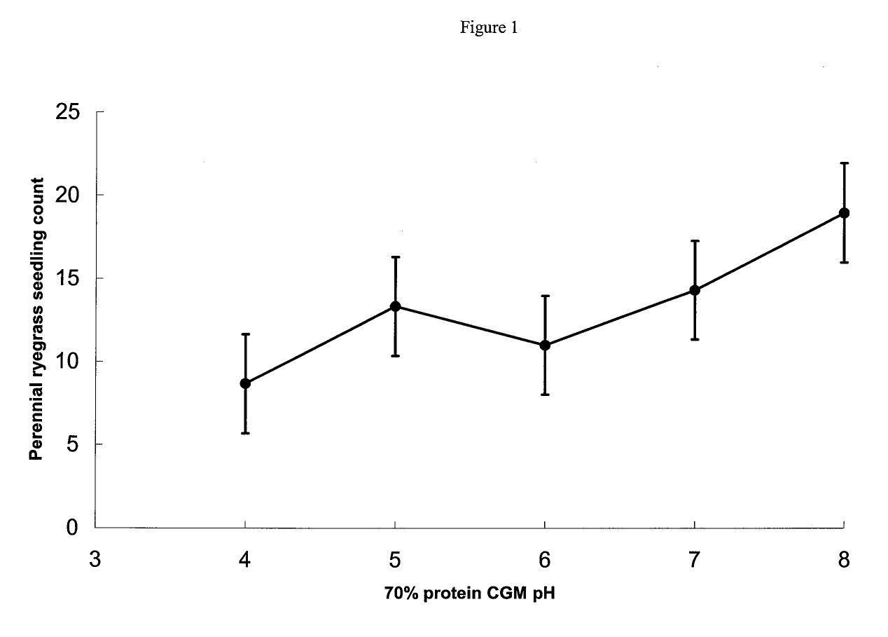

Adjustment of 70% protein CGM to pH 8 resulted in a mean perennial ryegrass seedling number of 19 which was 2.2 times greater than (P=0.0340) that observed for the unadjusted CGM (FIG. 1). This finding was contradictory to the original hypothesis.

### pH Adjustment II

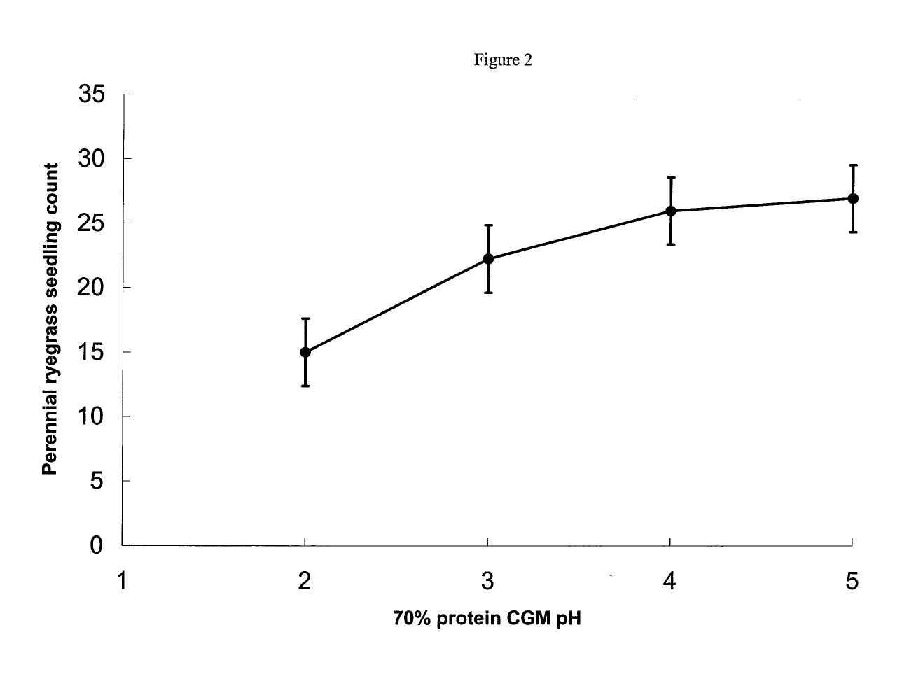

Adjustment to pH 2 of 70% protein CGM resulted in reductions of 42.3% (P=0.0117) and 44.4% (P=0.0071) in perennial ryegrass seedling counts compared to pH 4 (control) and pH 5, respectively (FIG. 2).

### pH Adjustment III

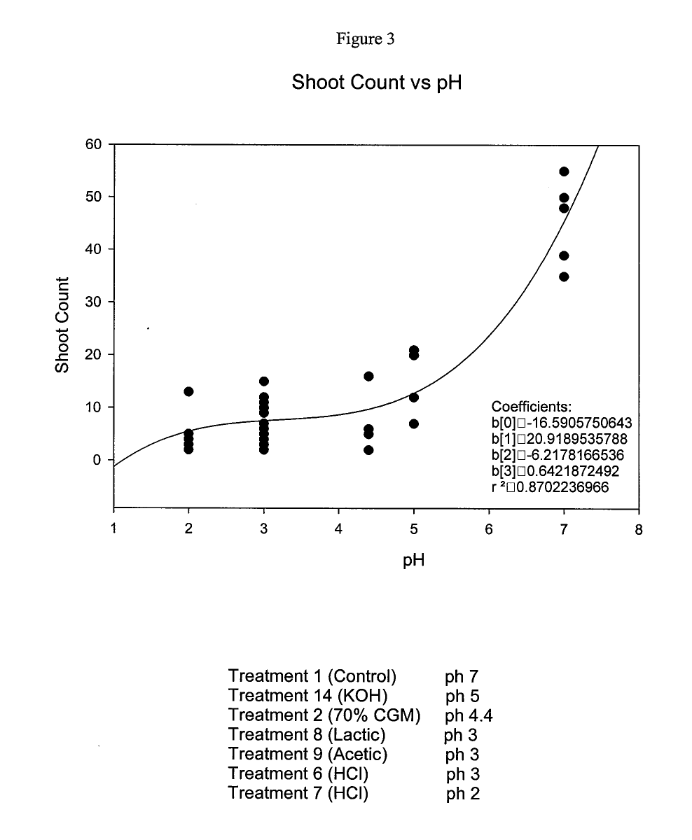

The data were analyzed using regression analysis (FIG. 3). All treatments reduced perennial ryegrass establishment as compared to the untreated control. Raising the pH of the 70% CGM material to pH 5 reduced its activity and acidifying it with acetic, lactic, and HCl increased activity. The green dye alone did not improve activity of the material.

### Discussion

Contradictory to the original hypothesis, increasing the pH of CGM decreased the observed efficacy. This observation led to the unexpected and surprising discovery that lowering the pH of CGM would increase efficacy. The inhibition of perennial ryegrass seedling numbers by CGM at pH 2 was greater than the control (pH 4). Thus, raising the pH of CGM material to pH 5 reduced its activity and acidifying it with acetic, lactic, and HCl increased activity.

### BIBLIOGRAPHY

Bingaman, B. R. and N. E. Christians. 1995. HortScience. 30:1256-1259.
Christians, N. E. 1991. U.S. Pat. No. 5,030,268.
Christians, N. E. 1993. Intl. Turf. Soc. Res. J. 7:284-290.
Environmental Protection Agency. 1997. Corn gluten; exception from the requirement of a tolerance. EPA, Washington, D.C.
Liu, D. L. and N. E. Christians. 1994. J. Plant Growth Regul. 13:227-230.
Liu, D. L. and N. E. Christians. 1996. J. Plant Growth Regul. 15:13-17.
Normecke, G. R. and N. E. Christians. 1993. Acta Hortic. 348:315-320.
SAS Institute Inc. 2003. Version 9.1. Cary, N.C.
Sterling, T. M. 1994. Weed Sci. 42:263-276.
Unruh, J. B.; N. E. Christians; and H. T. Horner. 1997. Crop Sci. 37:1870-1874.

All publications, patents and patent applications are incorporated herein by reference. While in the foregoing specification this invention has been described in relation to certain preferred embodiments thereof, and many details have been set forth for purposes of illustration, it will be apparent to those skilled in the art that the invention is susceptible to additional embodiments and that certain of the details described herein may be varied considerably without departing from the basic principles of the invention.

What is claimed is:

1. Isolated acidified corn gluten meal (CGM) prepared by the steps of:
a) adjusting pH of a gluten stream with an acid to a pH of lower than about 4.0; and
b) drying said pH adjusted gluten stream to yield said isolated acidified CGM,
wherein the gluten stream is separated from corn during corn wet milling processing.

2. Isolated acidified corn gluten meal (CGM) prepared by the steps of:
a) suspending CGM in water;
b) adjusting pH of said suspended CGM with an acid to a pH of lower than about 4.0; and
c) drying said pH adjusted suspended CGM to yield said isolated acidified CGM.

3. The CGM of claim 1, wherein the adjusted pH is about 2.0 to about 3.5.

4. The CGM of claim 1, wherein the adjusted pH is about 2.0 or about 3.0.

5. The CGM of claim 1, wherein the acid is hydrochloric acid, lactic acid, acetic acid or a combination thereof.

6. A method to prepare an acidified CGM comprising
a) adjusting pH of a gluten stream with an acid to a pH of lower than about 4.0; and
b) drying said pH adjusted gluten stream to yield said isolated acidified CGM,
wherein the gluten stream is separated from corn during corn wet milling processing.

7. A method to prepare an acidified CGM comprising
a) suspending CGM in water;
b) adjusting pH of said suspended CGM with an acid to a pH of lower than about 4.0; and
c) drying said pH adjusted suspended CGM to yield said isolated acidified CGM.

8. The method of claim 6, wherein the adjusted pH is about 2.0 to about 3.5.

9. The method of claim 6, wherein the adjusted pH is about 2.0 or about 3.0.

10. The method of claim 6, wherein the acid is hydrochloric acid, lactic acid, acetic acid or a combination thereof.

11. A method for selectively inhibiting the growth of undesirable plants in a plot of soil comprising applying acidified CGM prior to the emergence of the undesirable plants in an amount effective to inhibit the growth of the undesirable plants.

12. The method of claim 11, wherein the acidified CGM is applied in an amount effective to inhibit the root development of the undesirable plants.

13. The method of claim 11, wherein the plot of soil comprises desirable plants.

14. The method of claim 11, wherein the acidified CGM is applied after emergence of the desirable plants.

15. The method of claims 11, further comprising transplanting desirable plants into the plot of soil.

16. The method of claim 11, wherein the CGM is acidified to a pH of lower than about 4.0.

17. The method of claim 16, wherein the CGM has a pH of about 2.0 to about 3.5.

18. The method of claim 16, wherein the acidified CGM has a pH of about 2.0.

19. The method of claim 16, wherein the acidified CGM has a pH of about 3.0.

20. The method of claim 11, wherein the undesirable plants are grassy weeds or broadleaf weeds.

21. The method of claim 11, wherein the desirable plants are monocotyledonous plants.

22. The method of claim 11, wherein the desirable plants are turfgrasses.

23. The method of claim 11, wherein the desirable plants are dicotyledonous plants.

24. The method of claim 11, wherein the desirable plants are berry plants or ornamental flowers.

25. The method of claim 11, wherein the desirable plants are strawberries.

26. The method of claim 11, wherein the amount of acidified CGM applied to the plot is from about 5 to about 40 lbs. per 1000 square feet.
